(19) United States
(12) Patent Application Publication
(10) Pub. No.: US 2017/0260755 A1
(43) Pub. Date: Sep. 14, 2017

(54) SYNTHETIC DECKING PLANKS

(71) Applicant: Fortress Iron, LP, Garland, TX (US)

(72) Inventors: Matthew Carlyle Sherstad, Dallas, TX (US); Marc Minne, Johannesburg (ZA)

(73) Assignee: Fortress Iron, LP, Garland, TX (US)

(21) Appl. No.: 15/452,223

(22) Filed: Mar. 7, 2017

Related U.S. Application Data
(60) Provisional application No. 62/305,283, filed on Mar. 8, 2016.

(51) Int. Cl. E04F 15/02; E04F 15/10; B29C 47/00; E04B 1/00

(52) U.S. Cl. CPC E04F 15/02161; E04B 1/003; E04F 15/02183; E04F 15/10; B29C 47/0061; B29K 2027/06

(57) ABSTRACT

A decking plank includes a non-distressed surface with a first surface texture defining a plurality of wood grain depressions. The plank also includes a distressed surface with a second surface texture defining a plurality of wood grain depressions and a plurality of cross-grain depressions. An outdoor deck may be formed with the dual-sided deck planks. The deck may be constructed in one configuration where each of the dual-sided deck planks has the distressed surface facing upward and exposed. The deck may be constructed in a second configuration where the same planks are assembled to have the non-distressed surface facing upward and exposed.

### PRIORITY CLAIM

This application claims priority from U.S. Provisional Patent Application Ser. No. 62/305,283 filed on Mar. 8, 2016, which is hereby incorporated by reference.

### TECHNICAL FIELD

The present disclosure relates to construction materials, and more particularly to synthetic decking planks that simulate the look of lumber.

### BACKGROUND

Synthetic materials that have the appearance of lumber are known. Some of the synthetic materials are wood-plastic composite materials and others are formed with only polymer materials, such as polyvinyl chloride (“PVC”). Typically one side of the material appears like a particular type of wood, and the other side is featureless. Thus, only one side of the material is exposed after installation, for example, as an outdoor deck. However, a fence constructed with synthetic planks may appear from both sides to be one particular type of natural wood, and therefore the planks have the same wood grain features on both sides of the plank. The features that give the material a wood-like appearance include a simulated wood grain that generally runs the length of a plank.

Oftentimes, decks are constructed with a natural wood, and some home owners and contractors prefer that the natural wood appears to have been distressed. That is, the wood retains saw-marks or other marks that give the wood a particular character when the actual saw or mill marks are exposed on a support surface when installed as a deck or a hardwood floor.

What is needed is a synthetic decking plank that appears to be wood/lumber but is more versatile than conventional synthetic lumber/construction materials in that it has multiple appearances, depending on which of two surfaces is exposed as the support surface.

### SUMMARY

Embodiments of the present disclosure include a dual-sided deck plank. The dual-sided deck plank is an elongated plank formed of a synthetic material and has an appearance of a type of wood. The plank includes a non-distressed surface with a first surface texture defining a plurality of wood grain depressions. The plank also includes a distressed surface with a second surface texture defining a plurality of wood grain depressions and a plurality of cross-grain depressions. An outdoor deck may be formed with the dual-sided deck planks. The deck may be constructed in one configuration where each of the dual-sided deck planks has the distressed surface facing upward and therefore the distressed surface is the surface on which people walk and furniture and other items are supported. The deck may be constructed in a second configuration where the same planks are assembled to have the non-distressed surface facing upward and functioning as the surface supporting foot traffic and supporting other items, such as deck furniture.

A method of manufacturing dual-sided decking planks is also disclosed. The method includes forming an elongated plank from a synthetic material, which may be a composite including natural material such as wood particles or bamboo particles combined with a synthetic polymer. A first surface texture is applied to a first side, where the first surface texture includes a plurality of first wood grain depressions. A second surface texture is applied to a second side disposed opposite the first side, where the second surface texture includes a plurality of second wood grain depressions and a plurality of cross-grain depressions. The second wood grain depressions may be the same or different from the first wood grain depressions. According to one embodiment, the first surface texture and the second surface texture is formed sequentially, and according to an alternate embodiment, the first surface texture and the second surface texture are formed simultaneously.

Technical advantages of this type of decking plank include the ability for a supplier to reduce its inventory by stocking a single type of synthetic plank where a single piece of material has one appearance and forms one style of decking if installed in a first orientation with a first side exposed, and a second appearance (type of wood, distressed appearance, saw marks, kerf marks, mill marks, color of material, and the like) if a second side opposite to the first side is exposed when the deck is constructed.

Other technical advantages will be readily apparent to one of ordinary skill in the art from the following figures, descriptions, and claims. Moreover, while specific advantages have been described above, various embodiments may include all, some, or none of the enumerated advantages.

### BRIEF DESCRIPTION OF THE DRAWINGS

A more complete understanding of the present invention may be acquired by reference to the following Detailed Description when taken in conjunction with the accompanying Drawings wherein:

FIGS. 1A and 1B are perspective and plan views respectively of a portion of a an elongated decking plank and a distressed surface of the plank according to an embodiment of the present disclosure;

FIG. 2 is a plan view of a non-distressed surface of a synthetic decking plank;

FIG. 3 is a perspective view of a portion of a deck constructed with synthetic decking planks according to the teachings of the present disclosure where a distressed surface is exposed as a support surface;

FIG. 4 is a perspective view of a portion of a deck constructed with synthetic decking planks according to the teachings of the present disclosure where a non-distressed surface is exposed as a support surface; and

FIG. 5 is a perspective view of embossing wheels imprinting opposite side of an outer shell of a synthetic decking plank according to the teachings of the present disclosure.

### DETAILED DESCRIPTION OF THE DRAWINGS

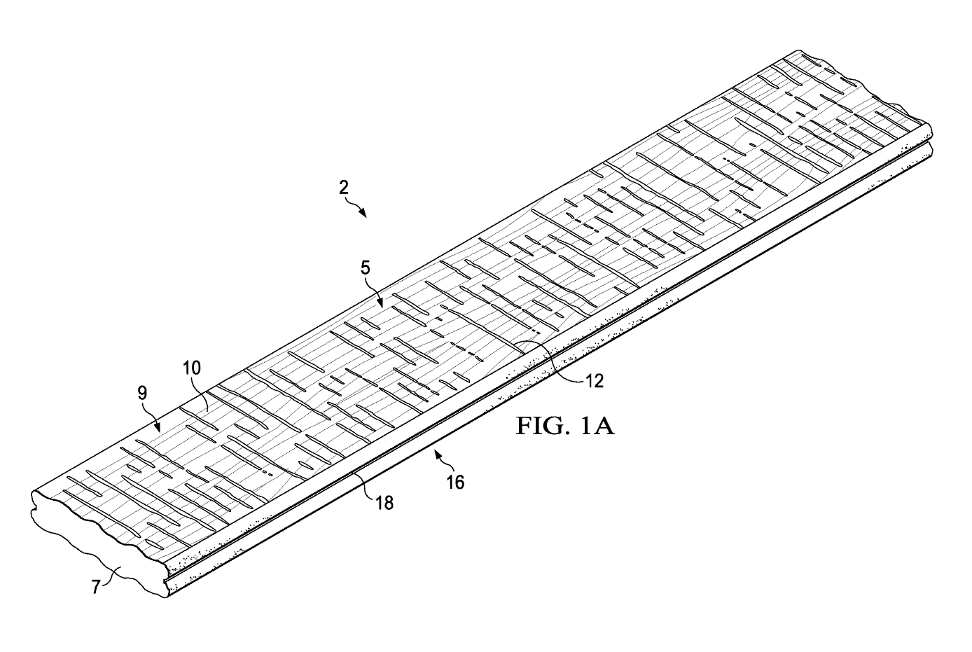

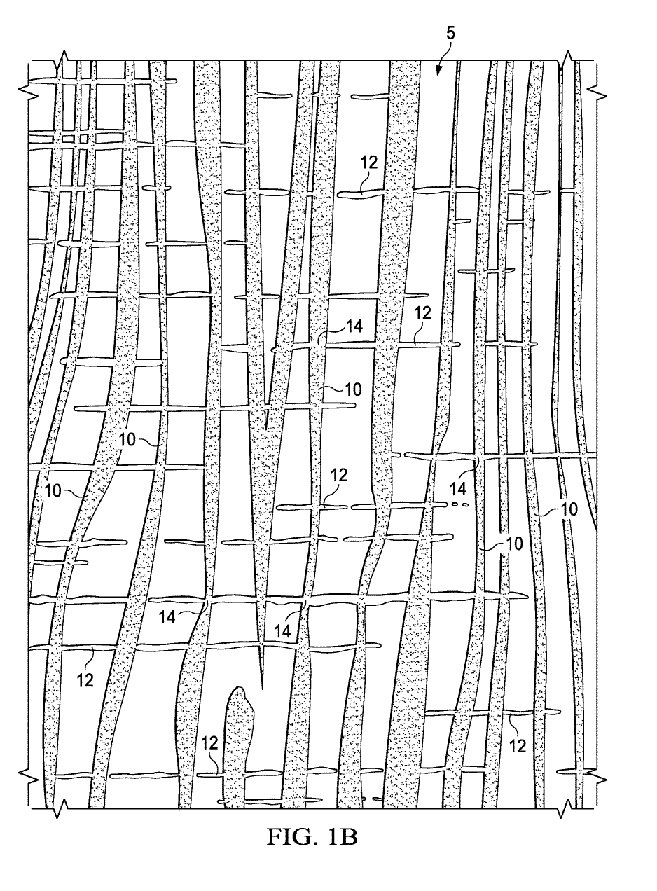

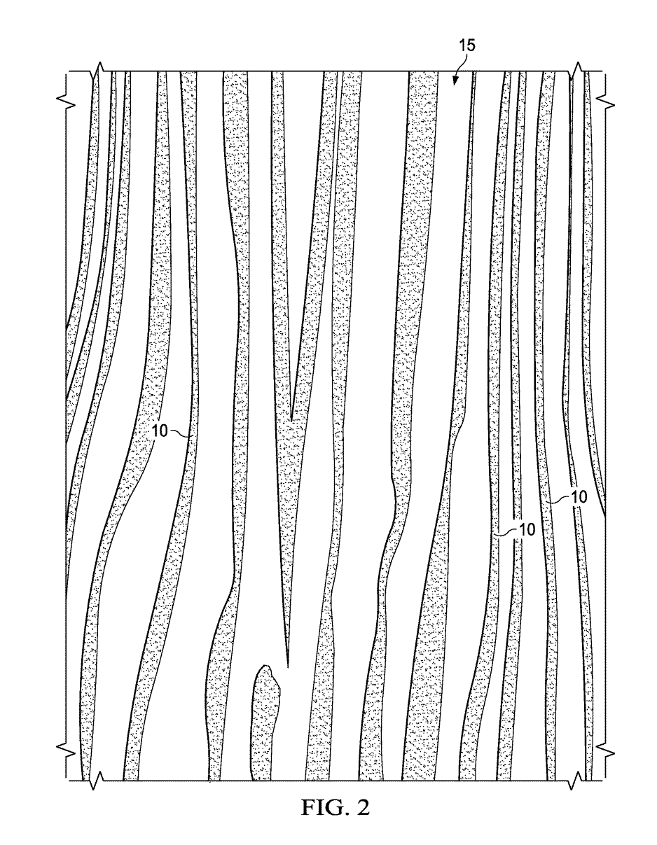

FIG. 1A is a plan view of a portion of a distressed deck surface of a synthetic plank 2 according to the teachings of the present disclosure. The plank 2 is formed of a composite material that includes wood particles or bamboo particles and a thermosetting and/or thermoplastic polymer, which may include virgin and/or recycled material. Such material may be generally referred to as synthetic material even though it may include some natural particles, such as natural wood particles or natural bamboo particles. According to an alternate embodiment, the plank 2 may be formed of only polymer material, such as polyvinyl chloride (“PVC”). The composite material or the PVC is extruded, injection molded, compression molded or other known polymer forming process into a deck plank 2.

In one embodiment, the plank 2 (also may be referred to as a panel) has a long dimension suitable for using the plank 2 to construct a deck. For example, the long dimension may be in the range of 12 feet to 24 feet. For example, common lengths of the long dimension are 12 feet, 16 feet, and 20 feet. A synthetic plank 2 originally formed to have a 12 foot long dimension may be cut to any suitable length, for example three planks 2 of four feet each or four planks 2 of three feet each. The synthetic planks 2 may have any suitable thickness, for example 0.5 inches to 2 inches. According to one embodiment, the synthetic planks 2 have a thickness of approximately 1 inch. The short dimension or width of the synthetic plank 2 may be any suitable dimension, for example 4-8 inches. In one embodiment, the short dimension is in the range of 5-6 inches. Some synthetic planks 2 have a short dimension or width suitable for stair risers or fascia planks 2. Such planks 2 may not directly support foot traffic but may be used in the construction of a complete deck. The width of such planks 2 may be in the range of 6 inches to 12 inches. For example, a stair riser may have a width in the range of 6 to 8 inches and a fascia plank may have a width in the range of 8 to 12 inches. The thicknesses of stair riser and fascia planks may be less than the decking planks 2 because they may be required to be more flexible. Thus, a thickness of a stair riser or fascia plank 2 may be in the range of one-eighth inch to one inch.

The synthetic plank 2 is subject to additional processes subsequent to the initial forming process. The subsequent processes may employ an embossing tool or embossing wheel, a stamping tool, a brush tool, or a roller to impart certain surface texture features to the plank 2. The surface texture features give the plank 2 an appearance of natural lumber. In one embodiment, the surface texture features may be a series of cross-grain depressions or troughs that simulate distress markings including saw or mill markings that might appear on natural wood that has been processed according to known wood sawing techniques.

According to certain embodiments, the plank may be formed of a core 7 of synthetic material that is encapsulated by a protective outer shell 9. The shell 9 provides the exposed surface and protects the inner core material. The shell 9 allows the plank 2 to be more durable and have a color that simulates natural wood. According to one embodiment, the shell 9 may be substantially thinner than the core 7 of the plank. For example, the shell 9 may have a thickness in the range of 1/32 of an inch to ¼ of an inch. The outer shell 9 receives embossing or stamping to form the distressed 5 and non-distressed 15 surface textures more fully described below.

In an example of manufacturing a plank using compression molding, a heated preform of synthetic material is placed in between a set of heated molding dies which have cavities that are machined to the final shape of the desired plank 2. The dies are closed applying the requisite molding pressure on the preform causing the synthetic material to flow and fill the die cavity, thereby replicating the desired shape of the plank. The die is subsequently opened after a prescribed molding period and the plank is removed and cooled.

In an example of producing the plank using an extrusion process, an extruder is employed which typically consists of a conical, twin screw, counter-rotating extruder material driving screw with a vent. At least one force feed hopper, crammer, or any other similar apparatus may be used to feed the materials into the extruder. The synthetic material may be extruded through at least one die. The die system may include a fold-up die, a calibrator, a sizer, or any other similar equipment for making extruded products. After exiting the die system, the plank 2 may be cooled. Similar to the injection molding process, the structural molding process may, for example, employ foaming agents and gas counter-pressure techniques to promote desirable density and physical performance characteristics in the produced plank 2.

According to one embodiment, a co-extrusion process is employed. With the co-extrusion process, the core 7 of the plank 2 and the outer protective shell 9 are formed simultaneously by the extrusion equipment. The core 7 may be formed of a first synthetic material, such as a wood or bamboo polymer composite or only a polymer material, and the outer shell 9 may be formed of a second material that is different than the first material. The material of the outer protective shell 9 may also be a wood or bamboo polymer composite or may be only a polymer material.

In an example of injection molding, the synthetic material is injected into molds which embody the shape and dimensions of the desired final plank 2.

As described in more detail below, the surface(s) of the molded or extruded plank 2 is subjected to one or more finishing steps, such as embossing, stamping, or brushing before or after cooling. According to one embodiment, a metal wire brush may be used to reduce light reflection of the outer shell 9 and make the plank 2 appear more like natural wood. The brush process may essentially remove the wood grain depressions from one side of the synthetic plank 2. Also, the introduction of a means of mechanically assembling individual planks 2, such as fasteners as examples, may be optionally performed in the molding process step, during the finishing step, or both as is applicable to the particular plank 2 desired. Alternatively, the fasteners may be applied to certain features of the plank 2 at the deck construction site.

The material used to form the synthetic plank 2 may include one or more of cellulosic-filled and/or inorganic-filled composite, which may include polymers, inorganic fillers, cross-linking agents, lubricants, and the like, as described in U.S. Pat. No. 8,074,339, titled “Methods of Manufacturing a Lattice Having a Distressed Appearance” to Brandt et al., which is hereby incorporated by reference. Examples of cellulosic fillers include sawdust, newspapers, alfalfa, wheat pulp, wood chips, wood fibers, wood particles, ground wood, wood flour, wood flakes, wood veneers, wood laminates, paper, cardboard, and the like.

With reference to FIGS. 1A and 1B, the distressed deck 5 surface of a synthetic plank 2 is illustrated. The distressed deck 5 surface is one of two surfaces that may be exposed as a support surface in constructing a deck out of the planks 2.

Running generally along a long dimension or length of the plank 2 are wood grain depressions 10. The wood grain depressions 10 simulate a natural grain of a piece of lumber. The wood grain depressions 10 may not exactly simulate a particular type of wood, but rather may simulate wood in general. Thus, the actual wood grain depressions 10 may be a conglomeration of different types of natural wood and/or artistic renderings of wood. In the actual wood grain depressions 10, factors associated with the plank 2 forming and the repetitive nature of the embossing wheel are taken into consideration such that exact replication of natural wood may not be possible or desirable.

The wood grain depressions 10 may be gently curved, but they generally extend the length of the plank 2. That is, they generally extend parallel to the long dimension of the plank 2. The wood grain depressions 10 are generally continuous along the length of the plank 2.

The distressed deck surface 5 may be colored and may have the wood grain depressions 10 in a pattern to simulate any type of wood or wood in general. For example, the color of the distressed deck surface 5 and the wood grain depressions 10 may have a look to simulate wood generally or a particular type of wood, such as oak, pine, Brazilian hardwood, such as Brazilian cherry, cedar, redwood, pressure treated wood, tropical hardwoods, and the like. The synthetic plank 2 may include coloring to appear to be natural, painted, or stained. If the distressed deck surface 5 is colored to appear to be stained wood, the surface may appear to have darker color at certain portions where the stained wood would naturally have darker color.

The distressed deck surface 5 also includes a plurality of cross-grain depressions 12, troughs, or channels. The cross-grain depressions 12 generally extend perpendicular to the wood grain depressions 10. The cross-grain depressions 12 may appear to be generally random saw or mill marks in the simulated wood surface texture. In certain embodiments, the cross-grain depressions 12 may not be exactly perpendicular to the wood grain depressions 10, but rather they may be slightly curved. In certain embodiments, the cross-grain depressions 12 may be arced to simulate marks of a circular saw.

The cross-grain depressions 12 may vary in depth into the plank 2, may vary in width in a direction parallel to the long dimension of the plank 2, and may vary in length in a direction perpendicular to the long dimension of the plank 2. According to one embodiment, one or more of the cross-grain depressions 12 may extend continuously over the short dimension of the plank 2, while other cross-grain depressions 12 may be discontinuous over the length of the short dimension of the distressed plank surface 5. According to certain embodiments, a depth of a single cross-grain depression 12 may vary to facilitate drainage and reduce or eliminate pooling of water or collection of dirt in the cross-grain depression 12.

At certain locations on the distressed deck surface 5 shown in FIG. 1B, a wood grain depression 10 intersects a cross-grain depression 12, as shown in FIG. 1B by reference number 14. According to certain embodiments, the cross-grain depressions 12 may extend to a longitudinal edge of the plank 2. This extension of the cross-grain depressions 12 to the edge also facilitates water drainage and reduces pooling and/or dirt collection.

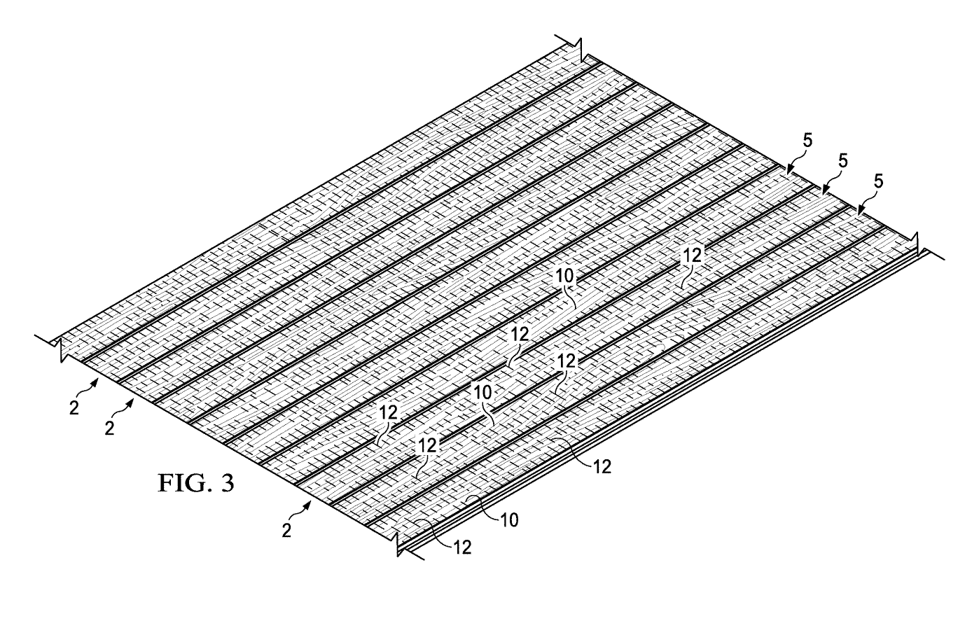

FIG. 3 illustrates a plan view of a non-distressed deck surface 15 of the plank 2 shown in FIG. 1A. According to one embodiment, the non-distressed deck surface 15 is a surface opposite the distressed deck surface 5. The non-distressed deck surface 15 may appear to be the same or a different type of wood as the distressed deck surface 5. In one embodiment, the non-distressed deck surface 15 appears to be the same wood, such as pine, and has the same color palate as the distressed deck surface 5. The non-distressed deck surface 15 does not include cross-grain depressions 12. Rather, the non-distressed deck surface 15 offers a second option for the construction of a deck to use the same synthetic planks 2 to construct a deck with either an exposed distressed deck surface 5 or an exposed non-distressed deck surface 15.

As described above, the non-distressed deck surface 15 includes the wood grain depressions 10 described above with respect to FIG. 1A. The wood grain depressions 10 are formed according to the processes described above including forming the wood grain depressions 10 in using processes subsequent to extruder forming, such as an embossing tool, such as an embossing wheel, a stamping tool or a roller brush. The distressed deck surface 5 may be formed simultaneously with the non-distressed surface 15 or the two surface textures may be formed in consecutive forming operations. According to an alternate embodiment, the surface of the synthetic plank 2 opposite the distressed deck surface 5 may be generally featureless in that it does not include the wood grain depressions 10, but the distressed surface 5 includes both the wood grain depressions 10 and the cross-grain depressions 12 as shown in FIG. 1A.

A side surface texture may be formed in a longitudinal side 16 of the plank 2 because a part of the side 16 proximate the exposed surface may be visible depending on the spacing of the planks 2 in the deck. The side surface texture may be formed by similar surface texturing processes that form the wood-grain depressions 10 and the cross-grain depressions 12. According to an alternate embodiment, the side surface texture is a surface texture of the outer shell 9 resulting from the co-extrusion process.

One or both sides 16 of the plank 2 may also include a groove 18 running parallel to the long dimension of the plank 2. The grooves 18 may receive certain hardware used to attach the planks 2 to other support structures and adjacent planks 2. An opposite side of the plank 2 may be generally the same as the illustrated side 16 and include the groove 18. Alternatively, the opposite side may include a groove 18 with different dimensions or may not include a groove 18 along the side extending parallel to the long dimension of the plank 2. According to an alternate embodiment, the synthetic plank 2 may include generally featureless sides that do not have a groove 18.

FIG. 3 illustrates a portion of a deck constructed with the planks 2 as shown and described with respect to FIGS. 1A and 1B. The deck shown in FIG. 3 is constructed with the distressed deck surface 5 of each plank 2 exposed. As such, the wood grain depressions 10 and the cross-grain depressions 12 are visible. The non-distressed deck surface 15 of the planks 2 is not visible in FIG. 3 because it is opposite and underneath the distressed deck surface 5.

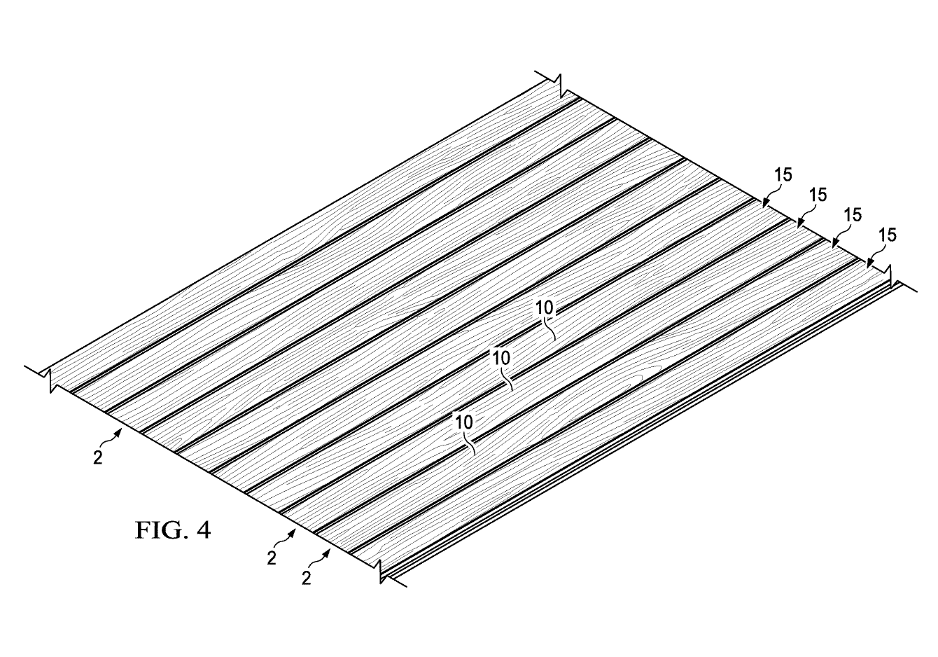

FIG. 4 illustrates a portion of a deck constructed with the planks 2 according to the teachings of the present disclosure where the non-distressed deck surface 15 is exposed and is facing upward. As such, only the wood grain depressions 10 are visible. Using the same planks, a deck can be constructed where the non-distressed deck surface 15 is exposed merely by flipping each of the planks 2 180 degrees such that the other side, the non-distressed deck surface 15 is facing upward and is therefore exposed.

According to the teachings of the present disclosure, a warehouse or supplier or distributor may stock one type of plank 2 that has two useable surfaces suitable for exposure as a support surface. In this manner, stocking and storing synthetic construction materials, such as decking planks is simplified. The supplier may fill an order for construction of either a deck exposing a distressed surface 5 or non-distressed surface 15 with the same planks 2. The installer may install the same planks 2 either with the distressed surface 5 exposed or the non-distressed surfaces 15 exposed. In the same deck, the installer also may install some planks 2 with the distressed surface 5 exposed and other planks 2 with the non-distressed surface 15 exposed. The exposure of two different surfaces on the same deck may be used to accent or highlight certain areas.

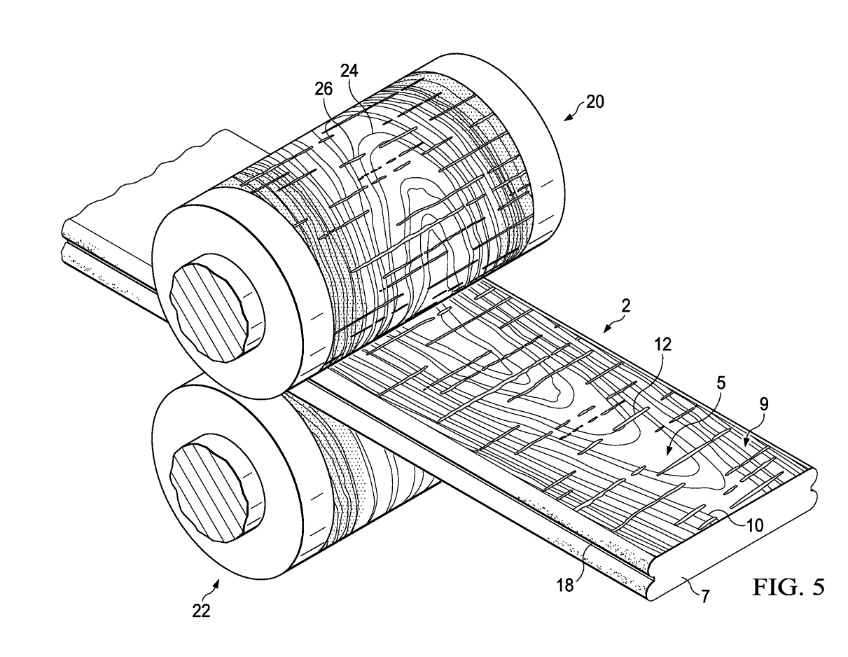

With reference to FIG. 5, in one exemplary method for forming the distressed surface 5 and the non-distressed surface 15 of the decking plank 2, a pair of embossing wheels 20, 22 are used to impart an embossed surface texture. A coextruded blank plank is fed through a pair of embossing wheels 20, 22. The embossing wheels 20, 22 impart the surface texture onto the surface of the plank 2. More specifically, the embossing wheels 20, 22 imprint surface texture by compressing the shell 9 that has been previously co-extruded with the core 7. The shell 9 may be heated to soften the shell 9 to allow the embossing wheels 20, 22 to impart the surface texture. According to one embodiment, an upper embossing wheel 20, 22 includes features that allow it to impart the distressed surface 5 on one side of the plank 2. For example, the upper embossing wheel 20 may include a wood grain raised design 24 and may also include a cross grain raised design 26 to imprint the cross grain depressions 12. Simultaneously, a lower embossing wheel 22 imprints a surface textures of the non-distressed surface 15 onto the opposite side of the plank 2. For example, the lower embossing wheel 22 may include raised wood grain features to imprint the features of the wood grain surface, such as the wood grain depressions 10. According to an alternate embodiment, both the upper and the lower embossing wheels 20, 22 impart the distressed surface 5 onto the both sides of the plank 2.

Although preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A deck plank, comprising:
a first surface;
a distressed surface disposed opposite the first surface, the distressed surface having a surface texture including a plurality of first wood grain depressions and a plurality of cross-grain depressions; and
wherein the deck plank comprises a material comprising a polymeric material and a cellulosic filler material.

2. The deck plank of claim 1 wherein the first surface comprises a plurality of second wood grain depressions.

3. The deck plank of claim 1 wherein the first wood grain depressions extend generally parallel to a long dimension of the deck plank and the cross-grain depressions extend generally perpendicular to the long dimension of the deck plank.

4. The deck plank of claim 1 wherein at least some of the first wood grain depressions are curved.

5. The deck plank of claim 1 wherein at least one of the cross-grain depressions extend to a longitudinal edge of the deck plank.

6. The deck plank of claim 1 wherein at least one of the cross-grain depressions varies in depth to facilitate drainage.

7. The deck plank of claim 1 wherein the plurality of first wood grain depressions has an appearance of a type of wood, the type of wood is selected from a group consisting of pine, cedar, redwood, cherry, and tropical hardwoods.

8. The deck plank of claim 1 wherein a side of the deck plank includes a groove extending a length of a long dimension of the deck plank.

9. The deck plank of claim 1 wherein the cellulosic filler material is bamboo particles.

10. A dual-sided deck plank, comprising:
a first surface having an appearance of a first type of wood and including a first surface texture defining a plurality of first wood grain depressions;
a second surface disposed opposite the first surface, the second surface having an appearance of a second type of wood different from the first type of wood and including a second surface texture defining a plurality of second wood grain depressions; and
wherein the dual-sided deck plank comprises a synthetic material.

11. The deck plank of claim 10 wherein the second surface further includes a plurality of cross-grain depressions simulating an appearance of saw marks.

12. The deck plank of claim 10 wherein the first type of wood is selected from a group consisting of pine, cedar, redwood, and cherry.

13. The deck plank of claim 12 wherein the second type of wood is selected from a group consisting of pine, cedar, redwood, and cherry.

14. A method of manufacturing a dual-sided synthetic decking plank, comprising:
forming an elongated plank;
forming a first surface texture to a first side, the first surface texture comprising a plurality of first wood grain depressions;
forming a second surface texture to a second side disposed opposite the first side, the second surface texture comprising a plurality of second wood grain depressions and a plurality of cross-grain depressions.

15. The method of claim 14 wherein forming the elongated plank comprises extruding a composite material through a die.

16. The method of claim 15 wherein the composite material comprises a cellulosic filler material and a polymer material.

17. The method of claim 16 wherein forming the second surface texture comprises contacting the second surface with an embossing tool, the embossing tool including a negative of the plurality of cross-grain depressions.

18. The method of claim 17 wherein the embossing tool further includes a negative of the plurality of second wood grain depressions.

19. The method of claim 14 wherein forming the second surface texture includes a process selected from a group comprising embossing, stamping, and brushing.

20. The method of claim 14 wherein forming the first surface texture and applying the second surface texture are performed sequentially.

21. The method of claim 14 wherein forming the first surface texture and applying the second surface texture are performed simultaneously.
